(19) United States
(12) Patent Application Publication
(10) Pub. No.: US 2021/0240889 A1
(43) Pub. Date: Aug. 5, 2021

(54) Discontinuous Interpolation Using Continuous Formulation, C1 or C0 FEM Discretization, and Scalable Solver

(71) Applicant: ExxonMobil Upstream Research Company, Spring, TX (US)

(72) Inventor: Volkan Akcelik, Spring, TX (US)

(21) Appl. No.: 17/248,470

(22) Filed: Jan. 26, 2021

Related U.S. Application Data
(60) Provisional application No. 62/969,730, filed on Feb. 4, 2020.

(51) Int. Cl. G06F 30/23; G06F 17/17; G06F 17/11

(52) U.S. Cl. CPC G06F 30/23; G06F 2111/04; G06F 17/11; G06F 17/17

(57) ABSTRACT

A methodology for discontinuous smooth interpolation in order to generate a curve of a discontinuous volume due to one or more faults in a subsurface is disclosed. Faults in a subsurface result in discontinuities in the subsurface. Hydrocarbon management may seek to determine various surfaces in the subsurface, including across the faults in the subsurface. To generate the various surfaces, a continuous formulation of the interpolation method is followed in which discontinuous smooth interpolation is viewed as a variational optimization problem (such as an energy optimization problem) for the surface curvature function. In this way, the methodology does not require that the input data be located at grid points and discretized with a structured regular grid. Rather, because a continuous function is used, an unstructured grid may also be used to discretize the resulting equation.

### CROSS REFERENCE TO RELATED APPLICATION

This application claims the priority of U.S. Provisional Application No. 62/969,730, filed Feb. 4, 2020, the disclosure of which is incorporated herein by reference in its entirety.

### TECHNICAL FIELD

This disclosure relates generally to the field of geophysical prospecting for hydrocarbon management and related data processing. Specifically, exemplary implementations relate to methods and apparatus for determining a discontinuous curve across a fault in a subsurface.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

A subsurface may include one or more faults, which may comprise one or more planar fractures or discontinuities in the subsurface (e.g., a discontinuity in a volume of rock across where there has been significant displacement as a result of rock-mass movement). Hydrocarbon management may seek to determine various surfaces in the subsurface, including across the faults in the subsurface. However, the discontinuity across the fault may make determining the surfaces difficult.

One method to determine the surfaces is via discontinuous smooth interpolation (DSI), or structural implicit modeling, which is an interpolation of randomly distributed sparse structural data. The structural data may comprise sparse scalar value, and/or sparse orientation given by:

Value constraints: u(xⱼ)=uⱼ* (1)

Orientation constraints: ∇u(xⱼ)=∥∇u(xⱼ)∥vⱼ (2)

where u(x) is the unknown surface curvature function to be interpolated, x is a point in the space, uⱼ* is a given scalar, and v₁ is a given unit vector. The objective of the DSI algorithm is to use the sparse data and faults' geometry as input to create a smooth surface representation by interpolating the sparse data, and by representing the discontinuities outlined by the faults' geometry (e.g., by solving for discrete (second) gradient operators, and using finite difference method and Cartesian grid).

### SUMMARY

A computer-implemented method for discontinuous smooth interpolation in order to generate a curve of a discontinuous volume due to one or more faults in a subsurface is disclosed. The method includes: accessing an at least partly continuous formulation; discretizing the at least partly continuous formulation with respect to a subsurface grid in order to generate a set of equations; solving the set of equations using the discontinuous smooth interpolation in order to generate the curve of the discontinuous volume by enforcing at least one of value constraints or orientation constraints; and using the curve in order to manage hydrocarbons or to output an image of the curve.

A computer-implemented method for discontinuous smooth interpolation in order to generate a curve of a discontinuous volume due to one or more faults in a subsurface is also disclosed. The method includes: generating a set of equations based on sparse scalar values and sparse orientation values; solving the set of equations in order to generate the curve by preconditioning an iterative solver, wherein the preconditioning includes using a combination of a multi-grid method and at least one other preconditioning method; and using the curve in order to manage hydrocarbons or to output an image of the curve.

A computer-implemented method for discontinuous smooth interpolation in order to generate a curve of a discontinuous volume due to one or more faults in a subsurface is further disclosed. The method includes: generating a set of equations using C¹ finite element method indicative of energy minimization; solving the set of equations using the discontinuous smooth interpolation in order to generate the curve of the discontinuous volume by enforcing at least one of value constraints or orientation constraints; and using the curve in order to manage hydrocarbons or to output an image of the curve.

### DESCRIPTION OF THE FIGURES

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is a graph of an example of a surface fitted to the structural data.

FIG. 2A is a graph showing interpolation of a first example with two points where the first and third derivative are set to zero (at both ends).

FIG. 2B is a graph showing interpolation of the first example with two points where the second and third derivative are set to zero (at both ends).

FIG. 3A is a graph showing interpolation of a second example with five points where the first and third derivative are set to zero (at both ends).

FIG. 3B is a graph showing interpolation of the second example with five points where the second and third derivative are set to zero (at both ends).

FIG. 4 is a graph showing interpolation of a third example with different a values, wherein the a value for the solid line is an order of magnitude greater than the a value for the dashed line.

FIG. 5 is a flow diagram of one example of the discontinuous smooth interpretation methodology.

FIG. 6 is an illustration of an example of discontinuous smooth interpretation, with sparse data, fault geometry and surface representation shown.

FIG. 7 is a contour view of constructed surface shown in FIG. 6.

FIG. 8 is a table of the scalability of the linear solver, with the number of linear iterations correlated to a different respective grid size.

FIGS. 9A, 9B, and 9C are representations of fault geometry, with FIG. 9A illustrating a regular gird and fault (curved line), FIG. 9B illustrating removing elements in the shaded area and introducing new boundaries, and FIG. 9C illustrating introducing new boundaries along the fault line without removing elements.

FIG. 10 illustrates fault discretization with unstructured mesh, whereby the fault line (shown as “ab”) is modeled with Neumann boundary conditions for both sides, and whereby there is no connection between both sides of the domain thereby creating discontinuity in the surface function u across the fault line.

FIG. 11 illustrates a fault line representation, with both sides of the fault line being modeled as an external boundary condition.

FIG. 12A illustrates a first representation of the fault line with discretization of the computational domain and FIG. 12B illustrates a second representation of the fault line with Ω contains all nodes (empty circle nodes and filled circle nodes), and Ω̅ contains empty circle nodes.

FIG. 13 is a diagram of an exemplary computer system that may be utilized to implement the methods described herein.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

The term “seismic data” as used herein broadly means any data received and/or recorded as part of the seismic surveying and interpretation process, including displacement, velocity and/or acceleration, pressure and/or rotation, wave reflection, and/or refraction data. “Seismic data” is also intended to include any data (e.g., seismic image, migration image, reverse-time migration image, pre-stack image, partially-stack image, full-stack image, post-stack image or seismic attribute image) or interpretation quantities, including geophysical properties such as one or more of: elastic properties (e.g., P and/or S wave velocity, P-Impedance, S-Impedance, density, attenuation, anisotropy and the like); and porosity, permeability or the like, that the ordinarily skilled artisan at the time of this disclosure will recognize may be inferred or otherwise derived from such data received and/or recorded as part of the seismic surveying and interpretation process. Thus, this disclosure may at times refer to “seismic data and/or data derived therefrom,” or equivalently simply to “seismic data.” Both terms are intended to include both measured/recorded seismic data and such derived data, unless the context clearly indicates that only one or the other is intended. “Seismic data” may also include data derived from traditional seismic (i.e., acoustic) data sets in conjunction with other geophysical data, including, for example, gravity plus seismic; gravity plus electromagnetic plus seismic data, etc. For example, joint-inversion utilizes multiple geophysical data types.

The terms “velocity model,” “density model,” “physical property model,” or other similar terms as used herein refer to a numerical representation of parameters for subsurface regions. Generally, the numerical representation includes an array of numbers, typically a 2-D or 3-D array, where each number, which may be called a “model parameter,” is a value of velocity, density, or another physical property in a cell, where a subsurface region has been conceptually divided into discrete cells for computational purposes. For example, the spatial distribution of velocity may be modeled using constant-velocity units (layers) through which ray paths obeying Snell's law can be traced. A 3-D geologic model (particularly a model represented in image form) may be represented in volume elements (voxels), in a similar way that a photograph (or 2-D geologic model) is represented by picture elements (pixels). Such numerical representations may be shape-based or functional forms in addition to, or in lieu of, cell-based numerical representations.

Subsurface model is a numerical, spatial representation of a specified region in the subsurface.

Geologic model is a subsurface model that is aligned with specified faults and specified horizons.

Reservoir model is a geologic model where a plurality of locations have assigned properties including rock type, environment of deposition (EoD), subtypes of EoD (sub-EoD), porosity, permeability, fluid saturations, etc.

For the purpose of the present disclosure, subsurface model, geologic model, and reservoir model are used interchangeably unless denoted otherwise.

Stratigraphic model is a spatial representation of the sequences of sediment and rocks (rock types) in the subsurface.

Structural model or framework results from structural analysis of reservoir based on the interpretation of 2D or 3D seismic images. For examples, the reservoir framework comprises horizons, faults and surfaces inferred from seismic at a reservoir section.

As used herein, “hydrocarbon management” or “managing hydrocarbons” includes any one or more of the following: hydrocarbon extraction; hydrocarbon production, (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include, well production rates (how much water, oil, or gas is extracted over time), well injection rates (how much water or CO₂ is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, discontinuous smooth interpolation (DSI) interpolates randomly distributed sparse data. One methodology is based on discrete (second) gradient operators that use a finite difference method on a Cartesian grid. Thus, this methodology is tied to the Cartesian grid (or other type of uniform grid), using the various constraints. In contrast, in one or some embodiments, a continuous formulation of the interpolation method is followed in which the DSI is viewed as a variational optimization problem (such as an energy optimization problem) for the surface curvature function u(x). In this way, unlike solutions that use a finite difference method and a Cartesian grid in order to discretize, the methodology does not require that the input data be located in grid points and discretized with structured regular grid. Rather, because a continuous function is used, an unstructured grid may also be used to discretize the resulting equation.

In particular, a goal of the optimization problem is to determine the optimal surface curvature function u(x) that minimizes an objective function (optionally with additional equality and/or inequality constraints on the surface curvature function u(x), as discussed in further detail below). In practice, a variational formula, which may be assumed to be a continuous function, may be written. A solution for the variational formula may be determined using energy minimization in which one or more forms of energy may be minimized, such as minimizing bending energy, in order to determine the variational formula. Similarly, other forms of energy may be minimized.

Further, various methods may be used for energy minimization of the continuous function. As one example, energy minimization of the continuous function may be based on the second derivative of the continuous function (e.g., squaring the second derivative of the continuous function and integrating over defined space, which results in a bi-harmonic equation (illustrated below, for example, in Equation (6)). Optionally, in addition to the bi-harmonic equation, one or more additional sparse (e.g., penalty) terms may be included. The sparse terms may include one or both of: (i) sparse measurements (e.g., one example of sparse measurements is a difference between values of u(x) and measured values or value constraints (uⱼ*, discussed above in Equation (1), for example, below as αΣᵢ₌₁^{N}^{ₚ}(uᵢ−uᵢ*) in Equation (6)); or (ii) orientation constraints (e.g., orientation constraints are discussed above in Equation (2) and are illustrated below, for example, as βΣⱼ₌₁^{N}^{ᵥ} (∇u−∥∇u∥vⱼ)²δ(xⱼ, yⱼ) in Equation (3)). Thus, the objective function may include the surface curvature function u(x) integrated over a given domain, and may include one or more alternative energy minimization terms. Each of these penalty terms may be weighted separately according to the desired smoothness of the function u(x).

Further, the surface curvature function u(x) may satisfy one or more equality constraints, such as in the form of boundary conditions at one or both of the edges of the domain or the fault lines (e.g., enforcing boundary conditions at one or both of the edges of the domain and the fault lines for one or both the value and orientation constraints). In practice, the constraints, such as one or both of the value or orientation constraints (illustrated above, for example, in Equations (1) and (2)), may be enforced either as soft constraints or hard constraints. In enforcing as soft constraints, one or more additional least squares term(s) may be added to the objective function (e.g., these additional least squares term(s) may be formed as the least squares difference of the surface (and/or its orientation) and sparse data (and/or sparse orientation)). In enforcing as hard constraints, the methodology may honor value constraints precisely by enforcing Equations (1) and/or (2) as strong constraints. In this regard, hard constraints are strictly honored whereas soft constraints are honored in a least squares sense.

Thus, the optimality system may be generated by taking variation and yields to a linear system of equations for the unknown surface curvature function u(x). In one or some embodiments, the optimality system may yield a 4^{th} order bi-harmonic equation. The linear optimality system may be solved using discretization, such as finite element method (FEM) discretization. FEM enables using an unstructured mesh, resolves complex geometries and fault lines, and allows for easier enforcement of natural boundary conditions. For example, an optimality system, represented as the 4th order bi-harmonic equation, may use a C¹ FEM for which both the discrete function and its first derivatives are continuous. C¹ comprises a function that is continuous and whose derivative is continuous. In an alternative approach to discretizing the 4^{th} order bi-harmonic, a mixed formulation may be used, which results in coupled 2^{nd} order equations, and may be solved using a FEM or FDM (finite difference method).

The linear system of equations may thus be solved using an iterative method, such as with a preconditioned conjugate gradient method. The preconditioner may use a multi-grid method in combination with one or more other preconditioners. As one example, the preconditioner may use a combination of the Jacobi method (diagonal scaling) and (geometric) multi-grid (MG) method. Alternatively, the preconditioner may use an algebraic multigrid method, which may be beneficial for the given problem when the discretization is performed using an unstructured grid.

In one or some embodiments, MG uses cross-grid operators to map u(x,y) or any other function (e.g., a residual of linear equation) from one grid to another. For example, MG may map from a coarser grid to finer grid or from a finer grid to a coarser grid. These MG operators may comprise interpolation operators (such as when mapping from a coarser grid to a fine grid) and restriction operators (such as when mapping from a fine grid to a coarse grid). In the present use of MG, since it is known that at the fault locations, the unknown u(x,y) is not continuous (the value u(x,y) jumps since the fault is “broken”), one may use the fault information to modify the interpolation and restriction operators, which in turn may improve the effectiveness of MG. In this regard, to further improve the linear convergence, the MG's cross-grid projection operators may be modified to account for the faults' discontinuities in which the so-called interpolation and restriction operators are modified.

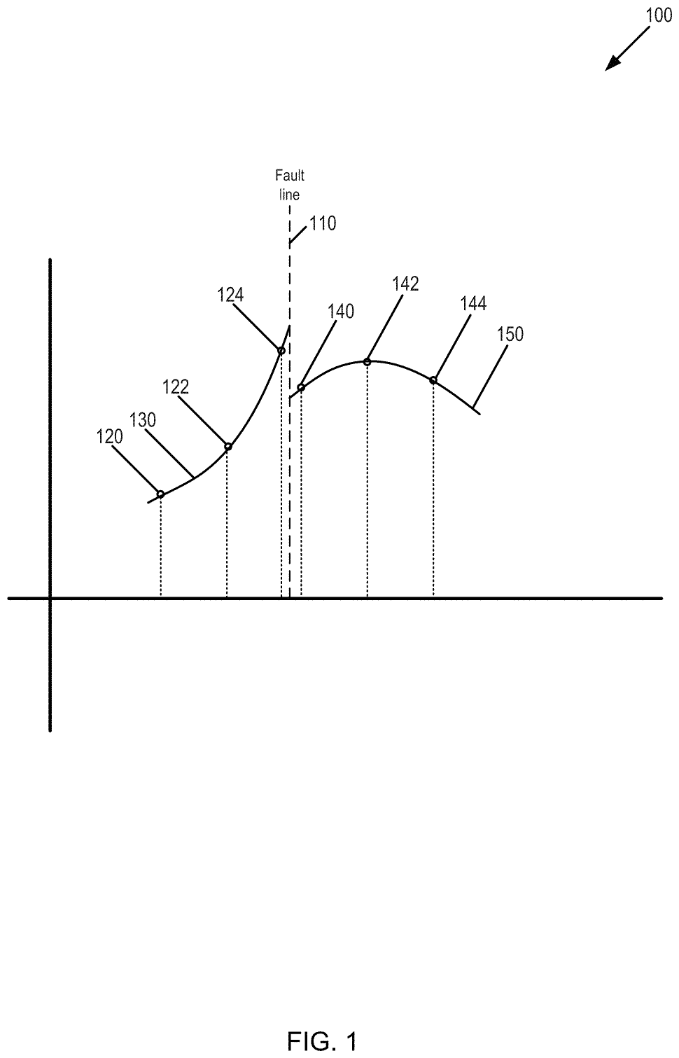

Referring to the figures, FIG. 1 is a graph 100 of an example of a surface fitted to the structural data. As shown, various structural data may be recorded at points 120, 122, 124, 140, 142, 144. The structural data may be used for the value and/or orientation constraints, such as described in Equations (1) and (2). Further, FIG. 1 illustrates a fault line 110, which results in a discontinuity in the surfaces at the fault line 110. Using the methodology disclosed herein, one or more curves may be fitted to the structural data, such as curve 130 and curve 150.

As discussed above, DSI or implicit geometric modeling may be solved as an energy minimization problem. The below disclosure is directed to the methodology in 1D or 2D. Any discussion herein regarding 1D or 2D may likewise be applied to 3D. Given a domain Ω with boundaries Γ, and sparse data u* at Nₚ location and orientation constraints ∥∇u(xⱼ)∥vⱼ at Nᵥ locations, the u(x) minimizes the following constrained objective function according to:

$$min S ( u ) := {\int }_{Ω}^{} {( \frac{{\partial }^{2} u}{\partial {x}^{2}} + \frac{{\partial }^{2} u}{\partial {y}^{2}} )}^{2} d Ω + {\int }_{Ω}^{} α {\sum }_{i = 1}^{{N}_{p}} {( u - {u}^{*} )}^{2} δ ( {x}_{i} , {y}_{i} ) d Ω + {\int }_{Ω}^{} β {\sum }_{j = 1}^{{N}_{v}} {( ∇ u - ‖ ∇ u ‖ {v}_{j} )}^{2} {δ ( {x}_{j} , {y}_{j} )}^{} d Ω \qquad ( 3 )$$

Subject to desired boundary conditions on the surface curvature function u(x, y) (e.g., homogeneous Neumann boundary conditions on boundaries and at the fault locations):

Δu=0 on Γ (4a)

∂ₙΔu=0 on Γ (4b)

The choice of boundary conditions may influence the quality of interpolation result. For example, homogeneous Neumann boundary conditions may be used, which is analogous to (in 2D) a mechanical system with zero shear force and moments at the ends. Alternatively, other types of boundary conditions may be used. The smoothness of the result may change with different choices of boundary conditions.

In addition, without these terms, the optimization problem may not complete. As discussed above, in one embodiment, separate from the bi-harmonic equation (see

$${( \frac{{\partial }^{2} u}{\partial {x}^{2}} + \frac{{\partial }^{2} u}{\partial {y}^{2}} )}^{2}$$

in Equation (3)), additional terms, such as the second term and third term in Equation (3) may represent the soft constraints desired to be enforced using a penalty term. Alternatively, hard constraints may be enforced, as discussed above.

The first term in Equation (3)

$$( {( \frac{{\partial }^{2} u}{\partial {x}^{2}} + \frac{{\partial }^{2} u}{\partial {y}^{2}} )}^{2} )$$

may represent the squared Laplacian energy. Other forms of energy terms are also contemplated. Further, the 1D equivalent of Equations (4a) and (4b) sets the second and third derivatives of u to zero at the both boundaries. For example, in 1D, setting the first derivative to zero forces surface curvature function u(x) to be flat next to the boundary.

The quality of smoothness of the generated function may be defined by one or more criteria, including any one, any combination, or all of: the objective function (e.g., energy norm used); the norm used in the data fit (e.g., L2 norm may be used; alternatively, other norms, such as L1 norm, may be used); the boundary conditions enforced; or additional penalty terms added as soft constraints.

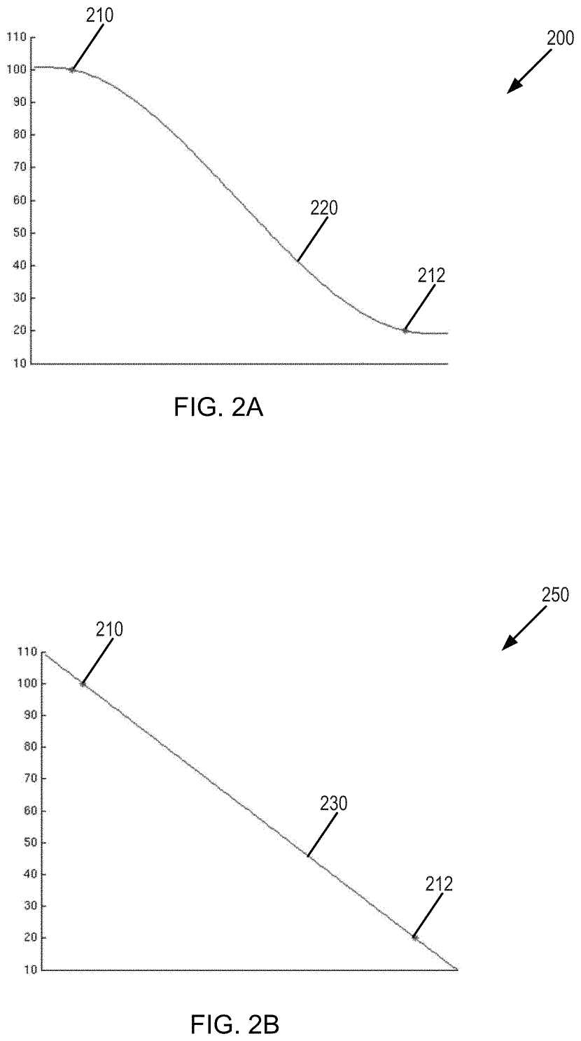

As a general matter, there may be an infinite number of ways in which to fit a curve or a surface to a set of points, such as illustrated in FIG. 1. As such, an appropriate curve or surface may be selected based on energy minimization along with value/orientation constraints and boundary conditions. FIGS. 2A-B and 3A-B include two 1D examples to explain boundary conditions and to illustrate the difference in results. In particular, FIG. 2A is a graph 200 showing interpolation to generate a curve 220 of a first example with two points 210, 212 where the first and third derivative at both ends are set to zero. FIG. 2B is a graph 250 showing interpolation to generate a line 230 of the first example with two points where the second and third derivative at both ends are set to zero.

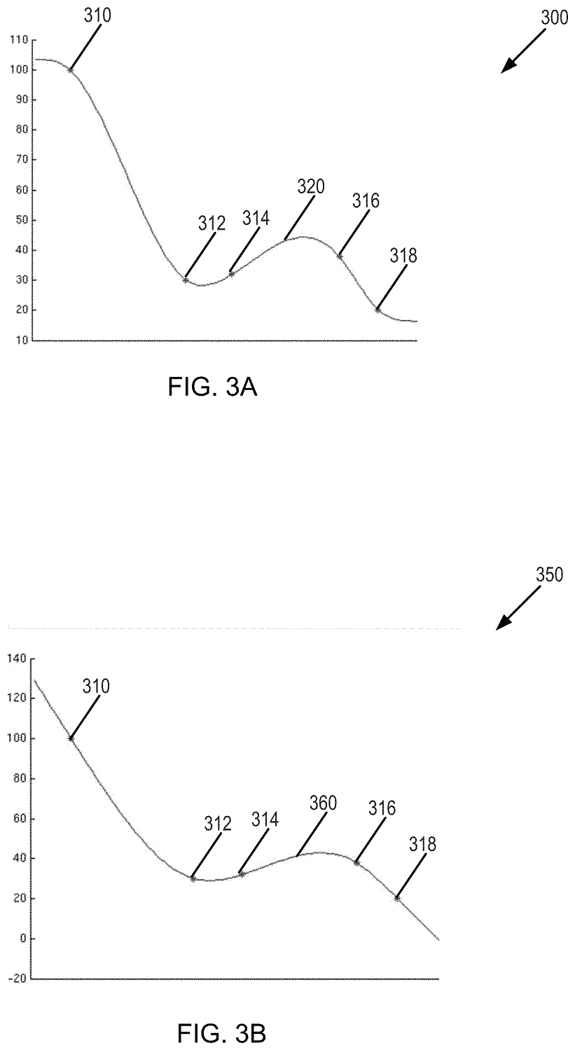

FIG. 3A is a graph 300 showing interpolation to generate a curve 320 of a second example with five points 310, 312, 314, 316, 318 where the first and third derivative are set to zero. FIG. 3B is a graph 350 showing interpolation to generate a curve 360 of the second example with five points 310, 312, 314, 316, 318 where the second and third derivative are set to zero. As shown in FIGS. 2A-B and FIGS. 3A-B, setting of different order derivatives at the boundaries to zero results in different curves being generated, including differences in one or more aspects of the curves.

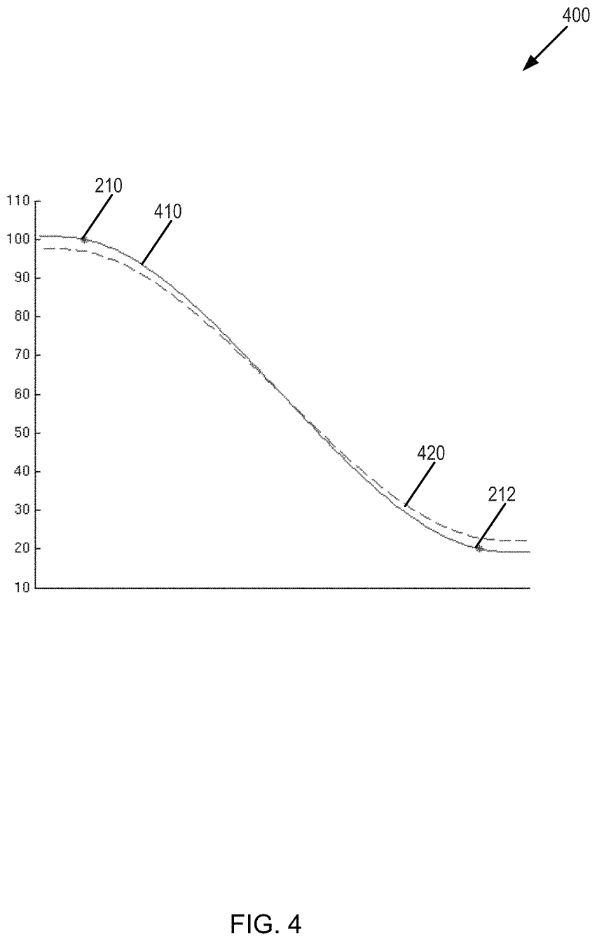

FIG. 4 is a graph 400 showing interpolation of a third example with different a values, wherein the a value for the solid line 410 is an order of magnitude greater than the a value for the dashed line 420. As discussed in more detail below, various values of a are contemplated. For example, a may comprise a constant value independent of location or may comprise a value that is location dependent. Further, different values for a may balance between closeness of the fit curve to the measured points versus smoothness of the fit curve. In the specific example of α=0, the fit curve may be a straight line. In this regard, the selection of a may depend on at least one aspect of the measurements at the measured points. For example, responsive to determining that the measurements may be error-prone, the a may be selected to emphasize smoothness as opposed to emphasizing closeness to the measured points. Conversely, responsive to determining that the measurements may be sufficiently reliable and accurate, the a may be selected to emphasize closeness to the measured points as opposed to emphasizing smoothness. In this way, the a may be selected depending on the confidence in the data measurements.

Thus, even though there may be many combinations of enforceable boundary conditions, in one or some embodiments, homogenous natural boundary conditions, such as described in Equations (4a) and (4b), may be used. To elaborate using an equivalent plate example, these homogenous natural boundary conditions correspond to zero force and zero moment at the boundaries, and along the fault lines.

Referring back to Equation (3), in one or some embodiments, α and β are scalar constants (and may also vary spatially in M. Further, in one or some embodiments, one or multiple requirements may be imposed separate from energy minimization, as discussed above. For example, additional requirements may be added either as a soft constraints (such as shown in Equation (3)) or as a hard constraints (such as shown in Equations (4a) and (4b)). In addition, one may also enforce inequality constraints on surface curvature function u(x) in one or more specified locations. The soft constraints, as illustrated in Equation (3), may be enforced in one or more ways, such as by using an L2 norm. Alternative norms may also be used, such as L1 norm. Selection of the norm may be determined by the expected noise level.

To derive the optimality of the given system, a Lagrangian is formed, where the boundary conditions may be enforced with introduced adjoint variables p and q on the boundary. For simplicity, the orientation term is removed:

$$ℒ ( u , p , q ) := {\int }_{Ω}^{} \frac{1}{2} {( \frac{{\partial }^{2} u}{\partial {x}^{2}} + \frac{{\partial }^{2} u}{\partial {y}^{2}} )}^{2} d Ω + {\int }_{Ω}^{} \frac{α}{2} {\sum }_{i = 1}^{{N}_{p}} {( u - {u}^{*} )}^{2} δ ( {x}_{i} , {y}_{i} ) d Ω + {\int }_{Γ}^{} p Δ u d Γ + {\int }_{Γ}^{} q {\partial }_{n} Δ u d Γ \qquad ( 6 )$$

Taking variation of Lagrangian with respect to its arguments and setting it to zero yields a desired optimality system as follows:

Δ²u+αΣᵢ₌₁^{N}^{ₚ₍ᵤ}ᵢ−uᵢ*)=0 in Ω (6)

Δu=0 on Γ (7)

∂ₙΔu=0 on Γ (8)

The optimality system in Equation (6) has two parts: (i) a bi-harmonic term (Δ²u); and (ii) a sparse mass term (αΣᵢ₌₁^{N}^{ₚ}(uᵢ−uᵢ*)). One may solve the bi-harmonic system in this form using a discretization technique. As one example, the bi-harmonic system may be solved by using a form of FEM, such as C¹ FEM discretization. Alternatively, other discretization techniques such as finite difference or boundary element methods, may be used. FEM may be more suitable for irregular mesh and may more easily enforce boundary conditions. In using C¹ FEM, additional degrees of freedom associated with derivatives at the vertices are introduced. For example, separate from the natural boundary conditions and the second and third derivatives of the surface curvature function u set to zero, one or more degrees (such as 3 degrees) of freedom may be set per node (e.g., u, du/dx, du/dy are continuous along element boundaries). Thus, the more complicated bi-harmonic equation is solved by superimposing a constraint (in the form of the derivative being continuous across FEM element boundaries), thereby enabling the use of C¹ FEM. FEM method is powerful for direct specification of tangents and curvatures along the boundary. It is noted that in 2D, when Nₚ≥3, Equation (6) yields a unique solution that defines the surface with the desired choice of boundary conditions.

An alternative approach to Equation (6) is to use a mixed FEM method. First, the following additional variable is introduced:

Δu=v in Ω (9)

Enforcing this as an equality condition, and introducing a new Lagrange variable λ, the mixed formulation minimizes the following objective function as follows:

$$ℒ ( u , λ , p 1 , p 2 ) := {\int }_{Ω}^{} \frac{1}{2} {v}^{2} + λ ( Δ u - v ) d Ω + {\int }_{Ω}^{} \frac{α}{2} {\sum }_{i = 1}^{{N}_{p}} {( u - {u}^{*} )}^{2} δ ( {x}_{i} , {y}_{i} ) d Ω + {\int }_{Γ}^{} p Δ u d Γ + {\int }_{Γ}^{} q ∇ Δ u \cdot n d Γ \qquad ( 10 )$$

Variation of this system with respect to all arguments results in the reduced optimality system to the following form:

First, variation with respect to v gives:

[symbol]

v\tilde{v}+λ\tilde{v}dΩ=0 (11)

[symbol]

(−∇u′∇\tilde{λ}−\tilde{λ}v)dΩ+ [symbol] \tilde{λ}∇u·ndΓ=0 (12)

[symbol]

−∇λ∇ũdΩ+ [symbol] ũ∇λ·ndΓ+ [symbol] αΣᵢ₌₁^{N}^{ₚ}ũ(u−u*)δ(xᵢ,yᵢ)dΩ+ [symbol] pΔũdΓ+ [symbol] q∇ũ·ndΓ=0 (13)

[symbol]

\tilde{p}ΔudΓ=0 (14)

[symbol]

\tilde{q}∇Δu·ndΓ=0 (15)

Equations (14) and (15) simply state the equivalent of Equations (4a) and (4b). From Equation (11), one may deduce that =λ in Ω. Equation (12) yields Equation (9). The last two terms of Equation (13) cancel due to Equations (4a) and (4b). Applying appropriate Green's identities to the first term of Equation (13) twice results in a form similar to the mixed finite element method as shown in the following:

Δv+αΣᵢ₌₁^{N}^{_{b}}(uᵢ−uᵢ*)=0 in Ω (16)

Δu=v in Ω (17)

with natural boundary conditions as in Equation (6). In this, with the introduction of additional variable, the original fourth-order equation is reduced to a second order equation, which may be discretized with linear finite elements. If one elects to use FEM, one may use C⁰ FEM, with C⁰ being a continuous function across the FEM element boundaries, but the derivatives are not continuous across the FEM element boundaries, as in C¹ FEM discretization. Alternatively, one may use other discretization methods, such as the finite difference method or the boundary element method.

Using an appropriate set of test functions, one may write the weak (or alternate) form of this equation by first defining V: H¹(Ω) and Q: H₀¹(Ω) and seeking u∈V and v∈Q such that:

[symbol]

∇v∇ψdΩ+αΣᵢ₌₁^{N}^{_{b}} [symbol] uᵢψdΩ=αΣᵢ₌₁^{N}^{_{b}} [symbol] uᵢψdΩ ∀ψ∈V, (18)

[symbol]

∇u∇φdΩ= [symbol] vφdΩ ∀φ∈Q (19)

It is noted that the choice of spaces enforces boundary conditions of Equations (4a) and (4b).

In using linear FEM discretization, in the form Σ_{i∈I}aᵢϕᵢ, the definition of these matrices are in the domain as follows:

$$\begin{matrix}{K}_{i , j} = {\int }_{{Ω}_{e}}^{} ( \frac{\partial {ϕ}_{i}}{\partial x} \frac{\partial {ϕ}_{j}}{\partial x} + \frac{\partial {ϕ}_{i}}{\partial y} \frac{\partial {ϕ}_{j}}{\partial y} ) d Ω & ( 20 ) \\ {M}_{i , j} = {\int }_{{Ω}_{e}}^{} ( {ϕ}_{i} {ϕ}_{j} ) d Ω & ( 21 ) \\ {N}_{i , j} = {\int }_{{Ω}_{e}}^{} α ( {ϕ}_{i} {ϕ}_{j} ) δ d Ω & ( 22 ) \\ {b}_{i} = {\int }_{{Ω}_{e}}^{} {αϕ}_{i} δ d Ω & ( 23 )\end{matrix}$$

This may be expressed in matrix form as follows:

$$[ \begin{matrix}{K}_{Ω , \overline{Ω}} & {N}_{Ω , Ω} \\ {M}_{\overline{Ω} , \overline{Ω}} & {K}_{\overline{Ω} , Ω}\end{matrix} ] ( \begin{matrix}{v}_{\overline{Ω}} \\ {u}_{Ω}\end{matrix} ) = ( \begin{matrix}{b}_{Ω} \\ 0\end{matrix} ) \qquad ( 24 )$$

In this, one may use Ω to denote all the degrees of freedom for a given variable, and Ω̅ to denote all the degrees of freedom except for those are at the boundary F. One may further simplify the equations by eliminating the second variable v using Equation (19), resulting in the following equation

(K_{Ω,Ω̅}M_{Ω̅,Ω̅}+N_{Ω,Ω})u_{Ω}=b_{Ω} (25)

In this reduced system, one may approximate the mass matrix M with lamping, further reducing the complexity of the problem. The advantage of which admits C⁰ elements, thereby makes computation more feasible. In contrast, designing C¹ elements may make computation more difficult for some applications.

Equation (6) may be discretized with C¹ FEM, resulting in a large scale symmetric positive definite system. Various ways are contemplated to solve the large scale symmetric positive definite system. In one or some embodiments, to solve this system, an iterative solver, such as a preconditioned conjugate gradient method, is used.

Various preconditioners are contemplated. In one or some embodiments, a multigrid method alone or in combination with another preconditioner may be used. In particular, preconditioning may comprise (or consist of) a combination of the Jacobi method and the geometric multi-grid method. In this regard, the multi-grid method is not being used as a solver, but as a preconditioner to be used in combination with an iterative solver. In addition, to further improve linear convergence of the solver, the cross grid operators (projection and restriction operators) may be modified to accommodate fault lines. Specifically, the multi-grid method may be modified to indicate the discontinuity at the fault. Thus, in one or some embodiments, preconditioning may first apply the Jacobi method (which may scale along the diagonal) and then apply multi-grid preconditioning.

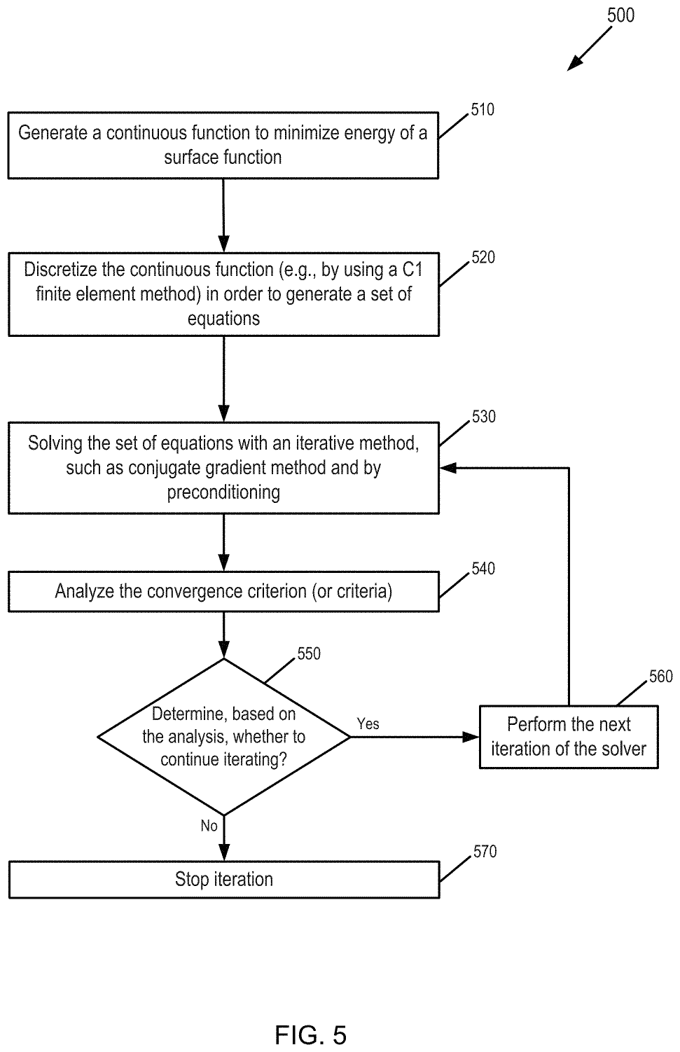

FIG. 5 is a flow diagram 500 of one example of the discontinuous smooth interpretation methodology. At 510, a continuous function to minimize energy of the surface function is generated. As discussed above, the surface function may comprise a bi-harmonic equation (optionally with one or more additional sparse terms). At 520, the continuous function may be discretized. As one example, C¹ FEM may be used to discretize the continuous function in order to generate a set of equations. Alternatively, C⁰ FEM may be used. At 530, the set of equations may be solved. As one example, the solver (such as an iterative solver like conjugate gradient method) may be preconditioned. As discussed above, various preconditioners are contemplated, such as a multi-grid method (or other type of multiresolution method) and/or Jacobi method.

At 540, one or more convergence criteria are analyzed. At 550, it is determined, based on the analysis of the one or more convergence criteria, whether to continue iteration. For example, the system may determine whether the residual is less than a certain amount (such as a predetermined amount). If so, flow diagram 500 proceeds to 570 to stop iterating. If not, flow diagram 500 proceeds to 560 in order to perform the next iteration of the solver.

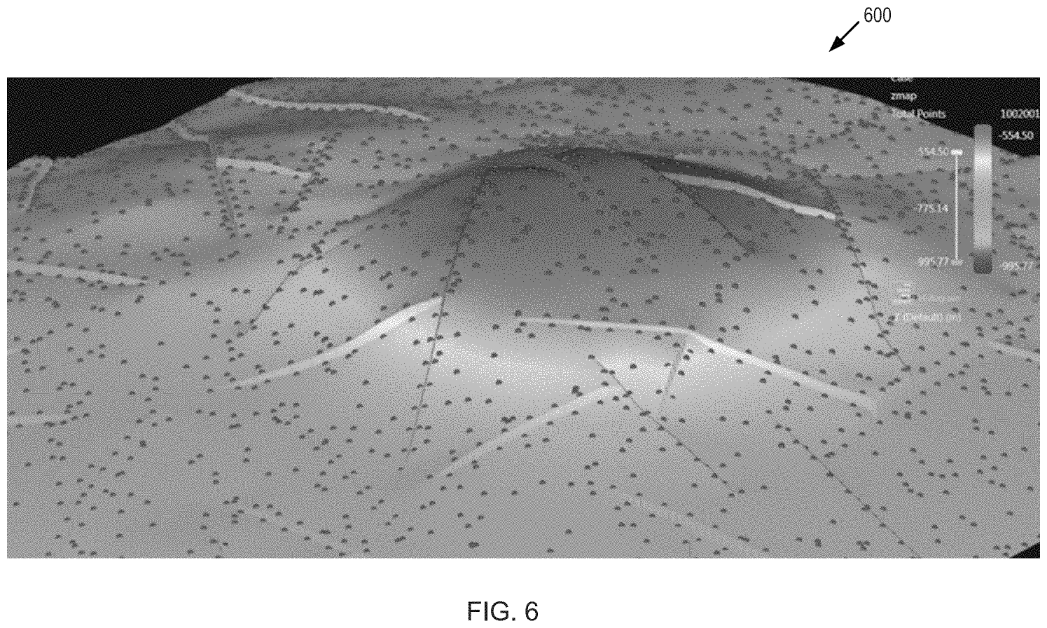

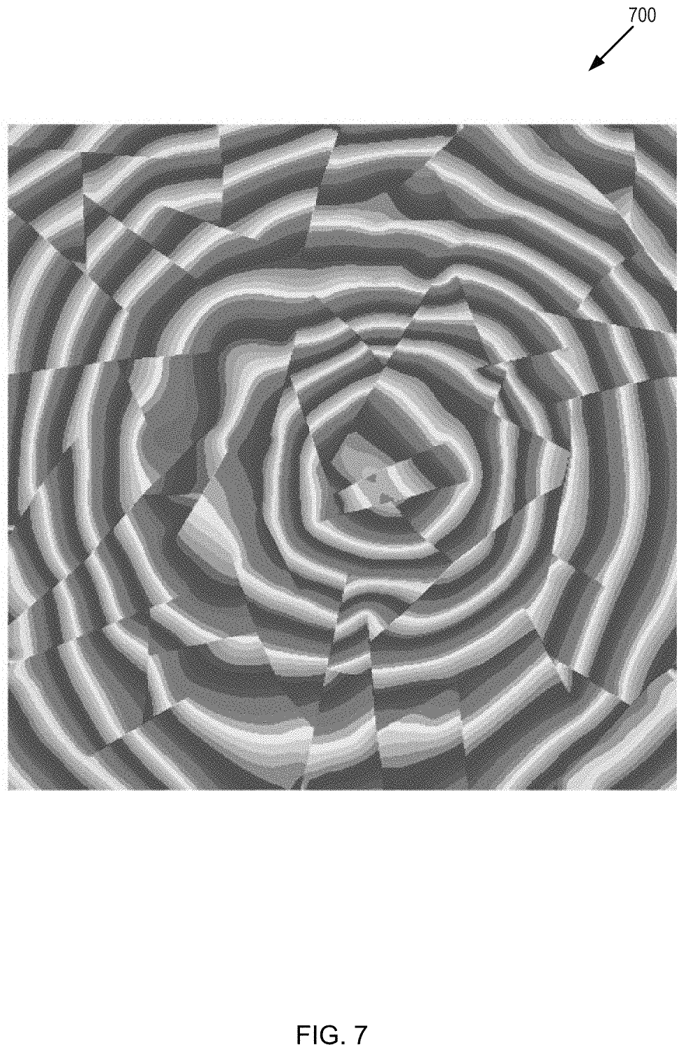

A DSI example of highly faulted model is shown in FIGS. 6 and 7. Specifically, FIG. 6 is an illustration 600 of an example of discontinuous smooth interpretation, with sparse data, fault geometry and surface representation shown, and FIG. 7 is a contour view 700 of constructed surface shown in FIG. 6.

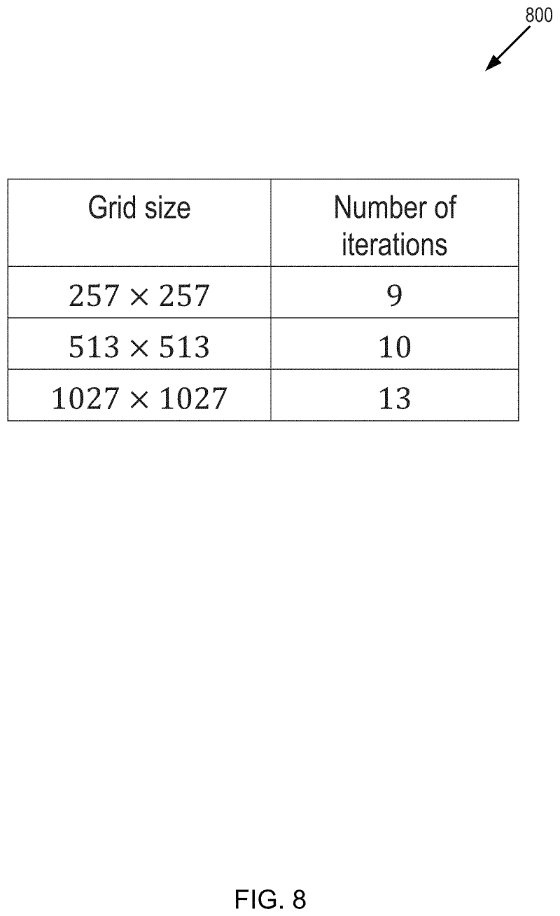

The given example may be solved with different grid resolutions. For example, FIG. 8 is a table 800 of the scalability of the linear solver, with the number of linear iterations correlated to a different respective grid size. As shown in table 800, even though the grid sizes increase, the number of iterations do not correspondingly increase (e.g., doubling the grid size from 257×257 to 513×513 only increases the number of iterations by 1). Thus, table 800 illustrates the effectiveness of preconditioning to reduce the number of iterations for convergence, with the performance and linear scalability of the solver shown. Further, the preconditioner may generally reduce the number of iterations versus iteratively solving without preconditioning.

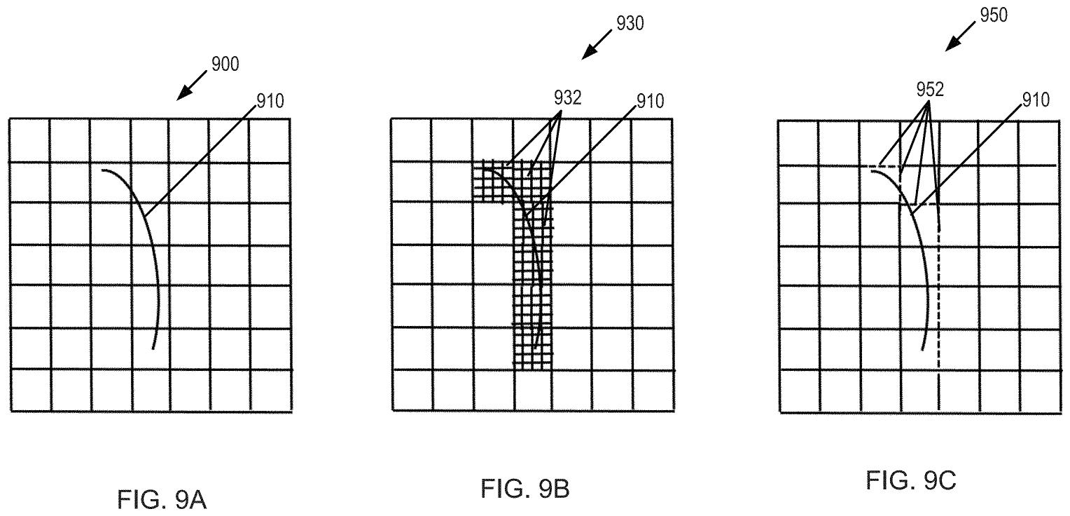

In implementing the methodology disclosed herein, the fault lines may be represented using one of several approaches. An example fault 910 on a regular grid is shown in illustration 900 of FIG. 9A. In particular, in the case of structured grid discretization, each fault may be represented using various approaches. In one or some embodiments, the fault may be discretized by removing one or more elements. In particular, a new boundary may be introduced, with the elements being removed from the optimization domain, and the introduction of one or more new boundaries. This is illustrated, for example, in the illustration 930 in FIG. 9B, in which elements 932 in the shaded area are removed and new boundaries are introduced. Thus, the shaded elements 932 illustrated in FIG. 9B are not considered part of the domain and are deleted from the computational domain, in effect acting like a thin (e.g., one grid size thick) hole inside the computational domain created by the fault, so that there is not a connection between two parts of the domain. The surface created by the shaded elements creates an external boundary and part of F in the formulation. One selection is a homogenous Neumann boundary condition (e.g., setting higher derivatives for u along the boundary to zero). Other selections are contemplated.

Alternatively, the fault may be discretized without removing any elements. In particular, in the structured grid, a closest edge in the grid to the fault may be used as the boundary. This is illustrated, for example, as dotted line 952 in the illustration 950 in FIG. 9C. Thus, discretization as illustrated in FIG. 9C does not remove any elements from the domain. This surface may also be represented as part of external boundary. Treatment of this boundary is similar to the illustration 950 in FIG. 9C, with the exception that there are now duplicate degrees of freedom for the nodes at the dotted surface, representing both sides of the fault. In this regard, in both FIGS. 9B and 9C, discretization the fault line may be approximated by a piece-wise continuous line. Alternatively, one may use an adaptive unstructured mesh, such as unstructured and/or adaptive FEM elements to improve fidelity of the boundary discretization.

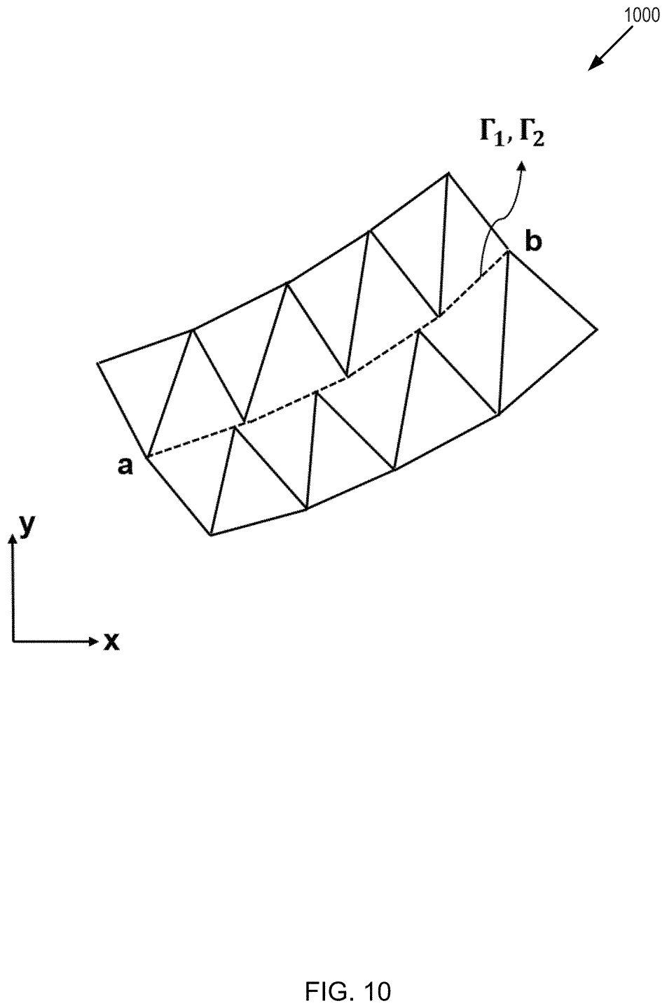

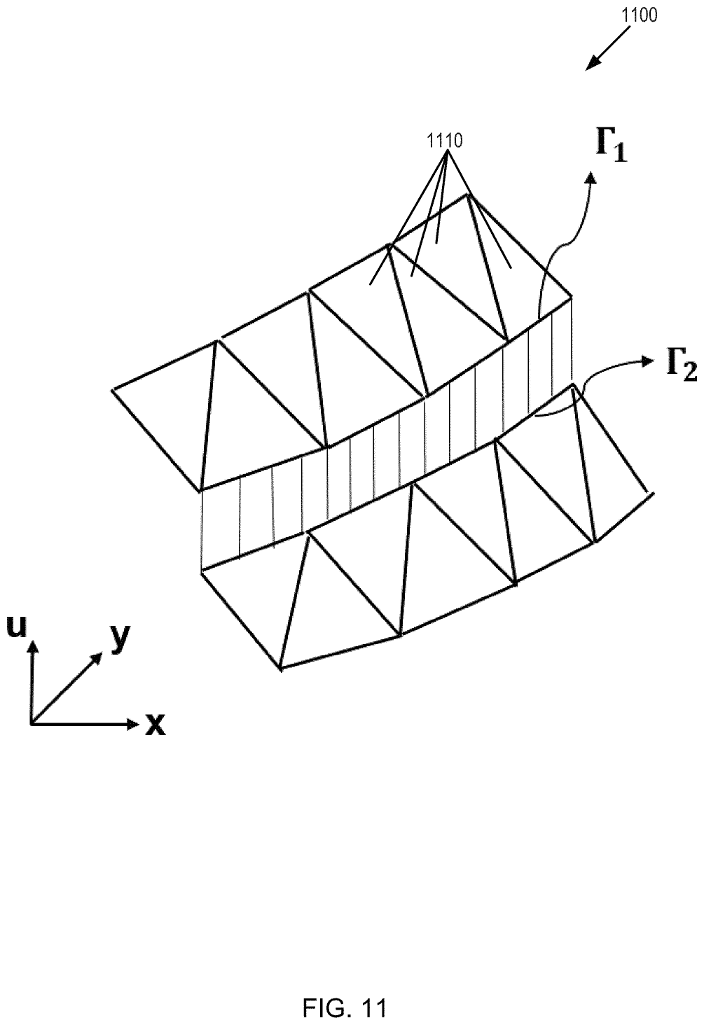

Further, FIG. 10 is an illustration 1000 of fault discretization with an unstructured mesh, whereby the fault line (shown as “ab”) is modeled with Neumann boundary conditions for both sides, and whereby there is no connection between both sides of the domain thereby creating discontinuity in the surface curvature function u across the fault line. FIG. 11 is an illustration 1100 of a fault line representation, with both sides of the fault line being modeled as an external boundary condition. Specifically, Γ₁ and Γ₂ are two separate surfaces acting as a boundary and created to highlight the discontinuity indicative of the fault. The boundary may be assigned one or more qualities, such as various derivatives being set to a predetermined value (e.g., one, any combination, or all of 1^{st} derivative, 2^{nd} derivative, 3^{rd} derivative being set to 0). Further, FIG. 11 illustrates irregular shapes 1110, which may be used by FEM.

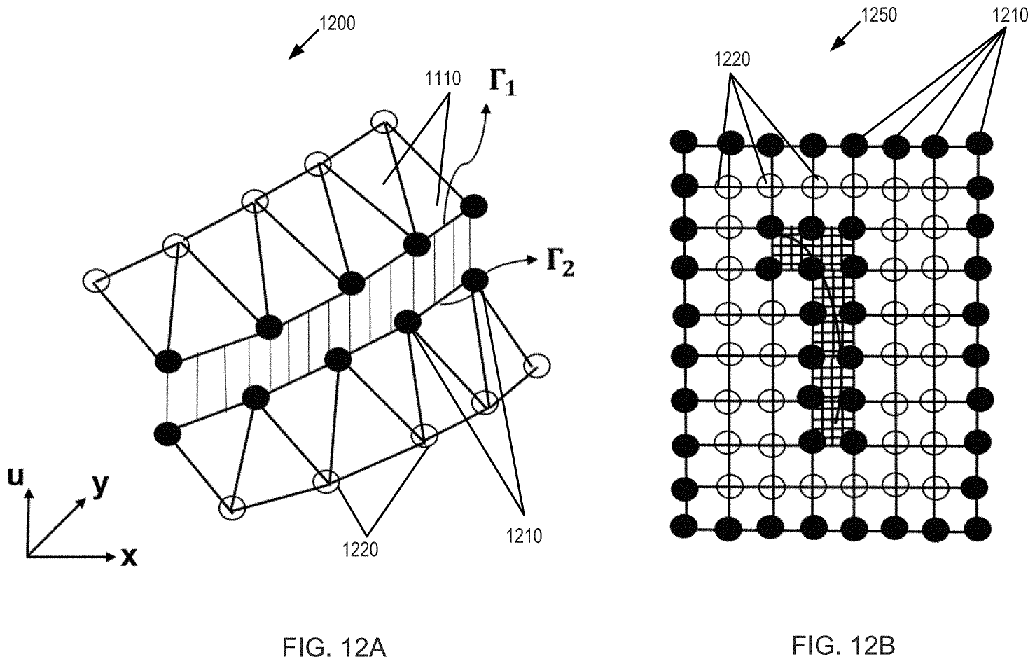

FIG. 12A is an illustration 1200 of a first representation of the fault line with discretization of the computational domain and FIG. 12B illustrates a second representation 1250 of the fault line with Ω contains all nodes (empty circle nodes 1220 and filled circle nodes 1210), and Ω̅ contains empty circle nodes 1220. As shown, filled circle nodes 1210 comprise boundary nodes and empty circle nodes 1220 comprise nodes inside the domain, wherein boundary conditions are enforced at the boundary nodes.

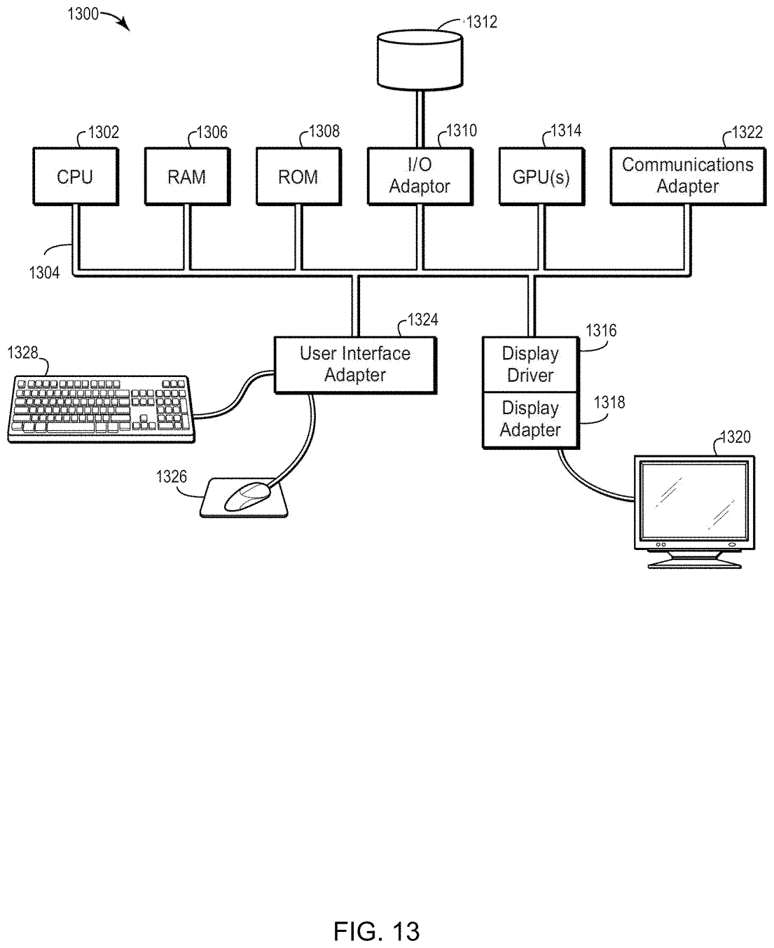

In all practical applications, the present technological advancement must be used in conjunction with a computer, programmed in accordance with the disclosures herein. For example, FIG. 13 is a diagram of an exemplary computer system 1300 that may be utilized to implement methods described herein. A central processing unit (CPU) 1302 is coupled to system bus 1304. The CPU 1302 may be any general-purpose CPU, although other types of architectures of CPU 1302 (or other components of exemplary computer system 1300) may be used as long as CPU 1302 (and other components of computer system 1300) supports the operations as described herein. Those of ordinary skill in the art will appreciate that, while only a single CPU 1302 is shown in FIG. 13, additional CPUs may be present. Moreover, the computer system 1300 may comprise a networked, multi-processor computer system that may include a hybrid parallel CPU/GPU system. The CPU 1302 may execute the various logical instructions according to various teachings disclosed herein. For example, the CPU 1302 may execute machine-level instructions for performing processing according to the operational flow described.

The computer system 1300 may also include computer components such as non-transitory, computer-readable media. Examples of computer-readable media include a random access memory (RAM) 1306, which may be SRAM, DRAM, SDRAM, or the like. The computer system 1300 may also include additional non-transitory, computer-readable media such as a read-only memory (ROM) 1308, which may be PROM, EPROM, EEPROM, or the like. RAM 1306 and ROM 1308 hold user and system data and programs, as is known in the art. The computer system 1300 may also include an input/output (I/O) adapter 1310, a graphics processing unit (GPU) 1314, a communications adapter 1322, a user interface adapter 1324, a display driver 1316, and a display adapter 1318.

The I/O adapter 1310 may connect additional non-transitory, computer-readable media such as storage device(s) 1312, including, for example, a hard drive, a compact disc (CD) drive, a floppy disk drive, a tape drive, and the like to computer system 1300. The storage device(s) may be used when RAM 1306 is insufficient for the memory requirements associated with storing data for operations of the present techniques. The data storage of the computer system 1300 may be used for storing information and/or other data used or generated as disclosed herein. For example, storage device(s) 1312 may be used to store configuration information or additional plug-ins in accordance with the present techniques. Further, user interface adapter 1324 couples user input devices, such as a keyboard 1328, a pointing device 1326 and/or output devices to the computer system 1300. The display adapter 1318 is driven by the CPU 1302 to control the display on a display device 1320 to, for example, present information to the user such as subsurface images generated according to methods described herein.

The architecture of computer system 1300 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 1300 may include various plug-ins and library files. Input data may additionally include configuration information.

Preferably, the computer is a high performance computer (HPC), known to those skilled in the art. Such high performance computers typically involve clusters of nodes, each node having multiple CPU's and computer memory that allow parallel computation. The models may be visualized and edited using any interactive visualization programs and associated hardware, such as monitors and projectors. The architecture of system may vary and may be composed of any number of suitable hardware structures capable of executing logical operations and displaying the output according to the present technological advancement. Those of ordinary skill in the art are aware of suitable supercomputers available from Cray or IBM or other cloud computing based vendors such as Microsoft, Amazon.

The above-described techniques, and/or systems implementing such techniques, can further include hydrocarbon management based at least in part upon the above techniques, including using the one or more generated geological models in one or more aspects of hydrocarbon management. For instance, methods according to various embodiments may include managing hydrocarbons based at least in part upon the one or more generated geological models and data representations (e.g., seismic images, feature probability maps, feature objects, etc.) constructed according to the above-described methods. In particular, such methods may include drilling a well, and/or causing a well to be drilled, based at least in part upon the one or more generated geological models and data representations discussed herein (e.g., such that the well is located based at least in part upon a location determined from the models and/or data representations, which location may optionally be informed by other inputs, data, and/or analyses, as well) and further prospecting for and/or producing hydrocarbons using the well. For example, the different stages of exploration may result in data being generated in the respective stages, which may be iteratively used by the machine learning to generate the one or more geological models discussed herein.

It is intended that the foregoing detailed description be understood as an illustration of selected forms that the invention can take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some or all of the steps in the disclosed method are performed using a computer so that the methodology is computer implemented. In such cases, the resulting physical properties model may be downloaded or saved to computer storage.

The following example embodiments of the invention are also disclosed:

Embodiment 1: A computer-implemented method for discontinuous smooth interpolation in order to generate a curve of a discontinuous volume due to one or more faults in a subsurface, the method comprising: accessing an at least partly continuous formulation; discretizing the at least partly continuous formulation with respect to a subsurface grid in order to generate a set of equations; solving the set of equations using the discontinuous smooth interpolation in order to generate the curve of the discontinuous volume by enforcing at least one of value constraints or orientation constraints; and using the curve in order to manage hydrocarbons or to output an image of the curve.

Embodiment 2: The method of embodiment 1: wherein the at least partly continuous formulation comprises an energy minimization function.

Embodiment 3: The method of any of embodiments 1 or 2, wherein the at least partly continuous formulation comprises a second derivative of a surface curvature function integrated over a given domain.

Embodiment 4: The method of any of embodiments 1-3, wherein the at least partly continuous formulation further comprises alternative energy minimization terms.

Embodiment 5: The method of any of embodiments 1-4, wherein the alternative energy minimization terms are based on the value constraints and the orientation constraints.

Embodiment 6: The method of any of embodiments 1-5, wherein the alternative energy minimization terms are one or more least squares terms formed as a least squares difference based on the value constraints and the orientation constraints.

Embodiment 7: The method of any of embodiments 1-6, wherein the alternative energy minimization terms are strictly honored as hard constraints.

Embodiment 8: The method of any of embodiments 1-7, wherein the at least partly continuous formulation comprises a 4th order bi-harmonic equation.

Embodiment 9: The method of any of embodiments 1-8, wherein discretizing the at least partly continuous formulation with respect to a subsurface grid in order to generate a set of equations comprises using a C¹ finite element method.

Embodiment 10: The method of any of embodiments 1-9, wherein the discretizing is on an irregular grid.

Embodiment 11: The method of any of embodiments 1-10, wherein the at least partly continuous formulation further comprises one or more additional sparse terms indicative of the at least one of value constraints or orientation constraints.

Embodiment 12: The method of any of embodiments 1-11, wherein the one or more additional sparse terms comprise one or more penalty terms; and wherein the one or more penalty terms include sparse measurements indicative of the value constraints and the orientation constraints.

Embodiment 13: The method of any of embodiments 1-12, wherein the sparse measurements comprise a difference between values of the curve and measured values.

Embodiment 14: The method of any of embodiments 1-13, wherein solving the set of equations comprises solving an objective function that includes a surface curvature function integrated over a given domain and one or more alternative energy minimization terms.

Embodiment 15: The method of any of embodiments 1-14, wherein the one or more alternative energy minimization terms comprise one or more equations indicative of sparse measurements and one or more equations indicative of the orientation constraints; and wherein the one or more equations indicative of sparse measurements and the one or more equations indicative of the orientation constraints are weighted separately according to a desired smoothness of the surface curvature function.

Embodiment 16: The method of any of embodiments 1-15, wherein solving the set of equations comprises preconditioning an iterative solver, wherein the preconditioning includes using a combination of a multi-grid method and at least one other preconditioning method.

Embodiment 17: A computer-implemented method for discontinuous smooth interpolation in order to generate a curve of a discontinuous volume due to one or more faults in a subsurface, the method comprising: generating a set of equations based on sparse scalar values and sparse orientation values; solving the set of equations in order to generate the curve by preconditioning an iterative solver, wherein the preconditioning includes using a combination of a multi-grid method and at least one other preconditioning method; and using the curve in order to manage hydrocarbons or to output an image of the curve.

Embodiment 18: The method of embodiment 17, wherein the at least one other preconditioning method comprises a Jacobi method.

Embodiment 19: The method of any of embodiments 17-18, wherein the preconditioning comprises first applying the Jacobi method and thereafter applying the multi-grid method.

Embodiment 20: A computer-implemented method for discontinuous smooth interpolation in order to generate a curve of a discontinuous volume due to one or more faults in a subsurface, the method comprising: generating a set of equations using C¹ finite element method indicative of energy minimization; solving the set of equations using the discontinuous smooth interpolation in order to generate the curve of the discontinuous volume by enforcing at least one of value constraints or orientation constraints; and using the curve in order to manage hydrocarbons or to output an image of the curve.

Embodiment 21: The method of embodiment 20, wherein the set of equations are generated by discretizing an at least partly continuous formulation with respect to a subsurface grid.

Embodiment 22: A non-transitory computer readable medium having stored thereon software instructions that, when executed by a processor, cause the processor to perform the method of any of embodiments 1-16.

Embodiment 23: A system comprising a processor and a memory, the processor in communication with the memory, the memory having stored thereon software instructions that, when executed by the processor, cause the processor to perform the method of any of embodiments 1-16.

Embodiment 24: A non-transitory computer readable medium having stored thereon software instructions that, when executed by a processor, cause the processor to perform the method of any of embodiments 17-19.

Embodiment 25: A system comprising a processor and a memory, the processor in communication with the memory, the memory having stored thereon software instructions that, when executed by the processor, cause the processor to perform the method of any of embodiments 17-19.

Embodiment 26: A non-transitory computer readable medium having stored thereon software instructions that, when executed by a processor, cause the processor to perform the method of any of embodiments 20-21.

Embodiment 27: A system comprising a processor and a memory, the processor in communication with the memory, the memory having stored thereon software instructions that, when executed by the processor, cause the processor to perform the method of any of embodiments 20-21.

### REFERENCES

The following references are hereby incorporated by reference herein in their entirety:
Curtis R. Vogel, Computational methods for inverse problems, Society for Industrial and Applied Mathematics (SIAM), 2002 ISBN-13: 978-0898715071.
A. Borzi and V. Schulz, “Computational Optimization of Systems Governed by Partial Differential Equations”, Society for Industrial and Applied Mathematics (SIAM), 2012 ISBN:1611972043 9781611972047.
J. Nodedal and S. J. Wright, Numerical Optimization, Second Edition, Springer Series in Operations Research and Financial Engineering 2000.
U. Trottenberg, C. Oosterlee, A. Schuller, Multgrid, Elseveir Academic Press, 2001, ISBN-13: 978-0127010700.
M. Ikarama, G. Laurent, J. Renaudeau, G. Caumen, “Finite difference implicit structural modeling of geological structures”, 2018 RING meeting, ASGA.
D. Terzopoulos, “The Computation of Visible-Surface Representations”, IEEE Transactions on Pattern Analysis and Machine Intelligence. Vol. 10, Issue: 4, July 1988.

1. A computer-implemented method for discontinuous smooth interpolation in order to generate a curve of a discontinuous volume due to one or more faults in a subsurface, the method comprising:
accessing an at least partly continuous formulation;
discretizing the at least partly continuous formulation with respect to a subsurface grid in order to generate a set of equations;
solving the set of equations using the discontinuous smooth interpolation in order to generate the curve of the discontinuous volume by enforcing at least one of value constraints or orientation constraints; and
using the curve in order to manage hydrocarbons or to output an image of the curve.

2. The method of claim 1, wherein the at least partly continuous formulation comprises an energy minimization function.

3. The method of claim 2, wherein the at least partly continuous formulation comprises a second derivative of a surface curvature function integrated over a given domain.

4. The method of claim 3, wherein the at least partly continuous formulation further comprises alternative energy minimization terms.

5. The method of claim 4, wherein the alternative energy minimization terms are based on the value constraints and the orientation constraints.

6. The method of claim 5, wherein the alternative energy minimization terms are one or more least squares terms formed as a least squares difference based on the value constraints and the orientation constraints.

7. The method of claim 5, wherein the alternative energy minimization terms are strictly honored as hard constraints.

8. The method of claim 3, wherein the at least partly continuous formulation comprises a 4^{th} order bi-harmonic equation.

9. The method of claim 8, wherein discretizing the at least partly continuous formulation with respect to a subsurface grid in order to generate a set of equations comprises using a C¹ finite element method.

10. The method of claim 9, wherein the discretizing is on an irregular grid.

11. The method of claim 8, wherein the at least partly continuous formulation further comprises one or more additional sparse terms indicative of the at least one of value constraints or orientation constraints.

12. The method of claim 11, wherein the one or more additional sparse terms comprise one or more penalty terms; and
wherein the one or more penalty terms include sparse measurements indicative of the value constraints and the orientation constraints.

13. The method of claim 12, wherein the sparse measurements comprise a difference between values of the curve and measured values.

14. The method of claim 1, wherein solving the set of equations comprises solving an objective function that includes a surface curvature function integrated over a given domain and one or more alternative energy minimization terms.

15. The method of claim 14, wherein the one or more alternative energy minimization terms comprise one or more equations indicative of sparse measurements and one or more equations indicative of the orientation constraints; and
wherein the one or more equations indicative of sparse measurements and the one or more equations indicative of the orientation constraints are weighted separately according to a desired smoothness of the surface curvature function.

16. The method of claim 1, wherein solving the set of equations comprises preconditioning an iterative solver, wherein the preconditioning includes using a combination of a multi-grid method and at least one other preconditioning method.

17. A computer-implemented method for discontinuous smooth interpolation in order to generate a curve of a discontinuous volume due to one or more faults in a subsurface, the method comprising:
generating a set of equations based on sparse scalar values and sparse orientation values;
solving the set of equations in order to generate the curve by preconditioning an iterative solver, wherein the preconditioning includes using a combination of a multi-grid method and at least one other preconditioning method; and
using the curve in order to manage hydrocarbons or to output an image of the curve.

18. The method of claim 17, wherein the at least one other preconditioning method comprises a Jacobi method.

19. The method of claim 18, wherein the preconditioning comprises first applying the Jacobi method and thereafter applying the multi-grid method.

20. A computer-implemented method for discontinuous smooth interpolation in order to generate a curve of a discontinuous volume due to one or more faults in a subsurface, the method comprising:
generating a set of equations using C¹ finite element method indicative of energy minimization;
solving the set of equations using the discontinuous smooth interpolation in order to generate the curve of the discontinuous volume by enforcing at least one of value constraints or orientation constraints; and
using the curve in order to manage hydrocarbons or to output an image of the curve.

21. The method of claim 20, wherein the set of equations are generated by discretizing an at least partly continuous formulation with respect to a subsurface grid.
